(19) United States
(12) Patent Application Publication
(10) Pub. No.: US 2025/0141874 A1
(43) Pub. Date: May 1, 2025

(54) SYSTEMS AND METHODS FOR USING ARTIFICIAL INTELLIGENCE TO FACILITATE SECURITY ACCESS MANAGEMENT

(71) Applicant: Capital One Services, LLC, McLean, VA (US)

(72) Inventors: Nilesh BHOYAR, Livingston, NJ (US); Adam HASINSKI, Vienna, VA (US); Kashish Paresh KOTHARI, Richmond, VA (US); Mohammad Nayaz ARSHAD, Glen Allen, VA (US); Fnu RUBIN THOMAS, Jersey City, NJ (US); Viral SHANKER, Hoboken, NJ (US)

(21) Appl. No.: 18/534,986

(22) Filed: Dec. 11, 2023

Related U.S. Application Data
(60) Provisional application No. 63/546,726, filed on Oct. 31, 2023.

(51) Int. Cl. H04L 9/40

(52) U.S. Cl. CPC H04L 63/102; H04L 63/108; H04L 63/20

(57) ABSTRACT

A system obtains a user profile that is associated with a user. The system determines, based on the user profile, and by using a first machine learning model, that the user is to be granted a security access and thereby causes the security access to be granted to the user. The system obtains, based on causing the security access to be granted to the user, user behavior information associated with the user. The system generates, based on the user behavior information, and by using a second machine learning model, certification information that indicates whether the security access is to be renewed or revoked. The system thereby causes the security access to be renewed when the certification information indicates that the security access is to be renewed, or the security access to be revoked when the certification information indicates that the security access is to be revoked.

### CROSS-REFERENCE TO RELATED APPLICATION

This patent application claims priority to U.S. Patent Application No. 63/546,726, filed on Oct. 31, 2023, and entitled “SYSTEMS AND METHODS FOR USING ARTIFICIAL INTELLIGENCE TO FACILITATE SECURITY ACCESS MANAGEMENT.” The disclosure of the prior application is considered part of and is incorporated by reference into this patent application.

### BACKGROUND

A security access can be granted (e.g., by an administrator or a manager) to allow a user (e.g., of a device) to access a resource, an environment, or an ability within a computer system or network.

### SUMMARY

Some implementations described herein relate to a system for using artificial intelligence to facilitate security access management. The system may include one or more memories and one or more processors communicatively coupled to the one or more memories. The one or more processors may be configured to obtain a user profile that is associated with a user. The one or more processors may be configured to determine, based on the user profile, and by using a first machine learning model, that the user is to be granted a security access. The one or more processors may be configured to cause, based on determining that the user is to be granted the security access, the security access to be granted to the user. The one or more processors may be configured to obtain, based on causing the security access to be granted to the user, user behavior information associated with the user. The one or more processors may be configured to generate, based on the user behavior information, and by using a second machine learning model, certification information that indicates whether the security access is to be renewed or revoked. The one or more processors may be configured to cause, based on the certification information, one of, the security access to be renewed when the certification information indicates that the security access is to be renewed, or the security access to be revoked when the certification information indicates that the security access is to be revoked.

Some implementations described herein relate to a non-transitory computer-readable medium that stores a set of instructions. The set of instructions, when executed by one or more processors of a system for using artificial intelligence to facilitate security access management, may cause the system for using artificial intelligence to facilitate security access management to determine, based on a user profile associated with a user, and by using a first machine learning model, that the user is to be granted a security access. The set of instructions, when executed by one or more processors of the system for using artificial intelligence to facilitate security access management, may cause the system for using artificial intelligence to facilitate security access management to cause, based on determining that the user is to be granted the security access, the security access to be granted to the user. The set of instructions, when executed by one or more processors of the system for using artificial intelligence to facilitate security access management, may cause the system for using artificial intelligence to facilitate security access management to generate, based on user behavior information associated with the user, and by using a second machine learning model, certification information that indicates whether the security access is to be renewed or revoked. The set of instructions, when executed by one or more processors of the system for using artificial intelligence to facilitate security access management, may cause the system for using artificial intelligence to facilitate security access management to cause, based on the certification information, one of, the security access to be renewed when the certification information indicates that the security access is to be renewed, or the security access to be revoked when the certification information indicates that the security access is to be revoked.

Some implementations described herein relate to a method. The method may include generating, by a system for using artificial intelligence to facilitate security access management, and by using one or more machine learning models, certification information that indicates whether a security access granted to a user is to be renewed or revoked. The method may include causing, by the system and based on the certification information, one of: the security access to be renewed when the certification information indicates that the security access is to be renewed, or the security access to be revoked when the certification information indicates that the security access is to be revoked.

### BRIEF DESCRIPTION OF THE DRAWINGS

FIGS. 1A-1F are diagrams of an example implementation associated with systems and methods for using artificial intelligence to facilitate security access management, in accordance with some embodiments of the present disclosure.

FIG. 2 is a diagram illustrating an example of training and using a machine learning model in connection with systems and methods for using artificial intelligence to facilitate security access management, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with using artificial intelligence to facilitate security access management, in accordance with some embodiments of the present disclosure.

FIG. 5 is a flowchart of an example process associated with systems and methods for using artificial intelligence to facilitate security access management, in accordance with some embodiments of the present disclosure.

### DETAILED DESCRIPTION

The following detailed description of example implementations refers to the accompanying drawings. The same reference numbers in different drawings may identify the same or similar elements.

To obtain a security access, a user (e.g., of a device) typically identifies the security access (e.g., by searching a security access directory) and then sends a request for the security access (e.g., using a security access management platform) to an authorization user (e.g., a manager, an administrator, or another user who has authorization to grant security accesses). This requires that the user know which security access the user needs, which may not be likely when the user is a new user (e.g., a new employee) or a role or position of the user has changed (e.g., the user has joined a new team or project, or is taking on different responsibilities for an existing team or project). This can result in the user requesting a security access even though the user does not need the security access. Further, because an authorization user is often overwhelmed with numerous security access requests at any moment in time, the user can be granted the security access even though the user does not need the security access and/or the user is not qualified to have the security access. Additionally, because of a sheer amount of already granted security accesses that need to be reviewed by the authorization user (e.g., during a periodic security access grant review), the security access, once given, is likely to be renewed even though the security is no longer needed by the user. This can result in an accumulation of security accesses by the user over time (often referred to as “security access creep” or “security access accumulation”).

An improper grant of a security access, and/or improper renewal of a no longer needed security access, can lead to improper access to a resource, an environment, or an ability within a computer system or network, which impacts an overall security and reliability of the computer system or network. Additionally, computing resources (e.g., processing resources, memory resources, communication resources, and/or power resources, among other examples) often must be used to address issues (e.g., security-related issues) that result from the improper security access grant or improper security access renewal.

Some implementations described herein include an analysis system for using artificial intelligence (e.g., using one or more machine learning models) to facilitate security access management. The analysis system obtains a user profile that is associated with a user, and thereby determines (e.g., using a first machine learning model) that the user is to be granted a security access. The analysis system then causes the security access to be granted to the user (e.g., by automatically granting the security access to the user, or by enabling another user, such as an administrator or manager, to authorize granting the security access to the user).

In some implementations, the analysis system (e.g., after causing the security access to be granted to the user) obtains user behavior information associated with the user, and thereby generates (e.g., using a second machine learning model) certification information that indicates whether the security access is to be renewed or revoked. For example, the analysis system determines (e.g., using the second machine learning model) user information that indicates whether the user continues to need the security access to be granted, whether behavior of the user is normal user behavior, and/or whether usage of the security access by the user is recent, among other examples. The analysis system then generates the certification information based on the user information, such that the certification information indicates that the security access is to be renewed (e.g., when the user information indicates that the user continues to need the security access to be granted, the behavior of the user is normal user behavior, and/or that usage of the security access by the user is recent) or is to be revoked (e.g., when the user information indicates that the user does not continue to need the security access to be granted, the behavior of the user is not normal user behavior, or the usage of the security access by the user is not a recent usage). The analysis system thereby causes the security access to be renewed (e.g., automatically renewed) when the certification information indicates that the security access is to be renewed, or the security access to be revoked (e.g., automatically revoked, or by enabling authorization by another user) when the certification information indicates that the security access is to be revoked.

In this way, the analysis system uses artificial intelligence to facilitate security access management, such as by facilitating grant and/or renewal of a security access to a user when the user needs the security access and/or the user's behavior justifies grant of the security access to the user, and by facilitating denial and/or revocation of the security access when the user does not need the security access and/or the user's behavior does justify grant of the security access to the user. The analysis system thereby increases a likelihood that requests, as well as grants and/or denials, are for security accesses that are needed by a user (e.g., instead of for any security access that a user may specify), which reduces an amount of computing resources (e.g., processing resources, memory resources, communication resources, and/or power resources, among other examples) of a device of another user (e.g., administrator or manager) that would otherwise be used to review, and approve and/or deny, needless requests.

Further, the analysis system improves a likelihood that a security access will be granted to, and renewed for, a user (e.g., of devices) that needs the security access and/or exhibits proper user behavior. This minimizes a likelihood of an improper security access grant and/or renewal, as well as a potential magnitude of harm that results from the improper security access grant and/or renewal. The analysis system therefore improves an overall security and reliability of a device, an environment, or a network associated with the security access. Further, the analysis system minimizes, or prevents, wastage of computing resources that would otherwise be used to address issues (e.g., security-related issues) that result from an improper security access grant and/or renewal.

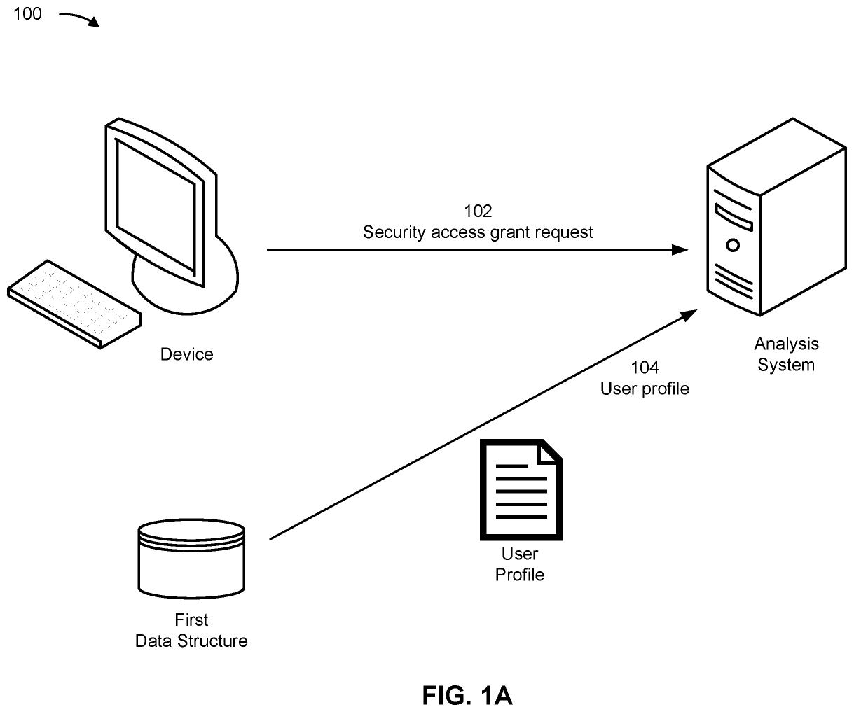

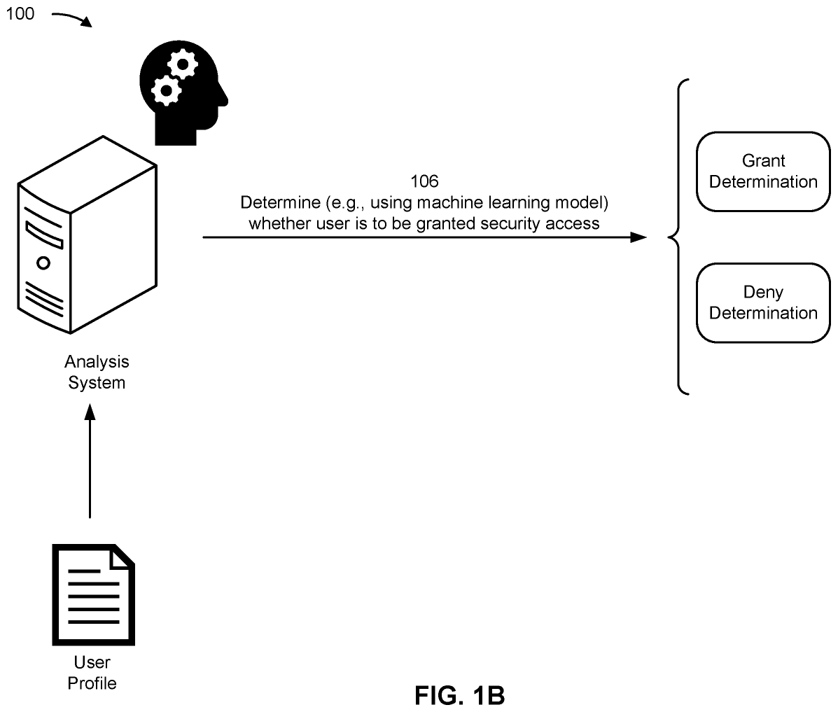

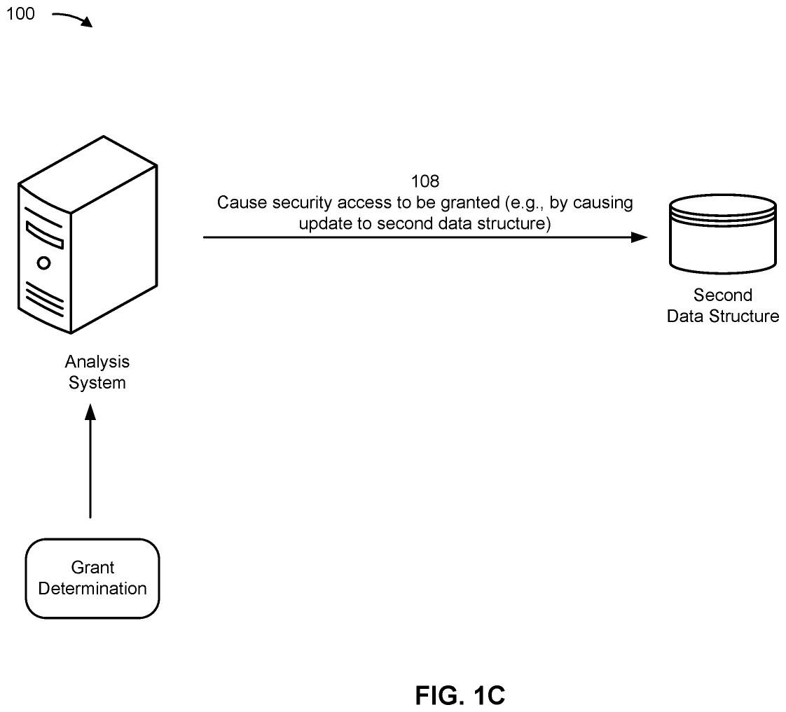

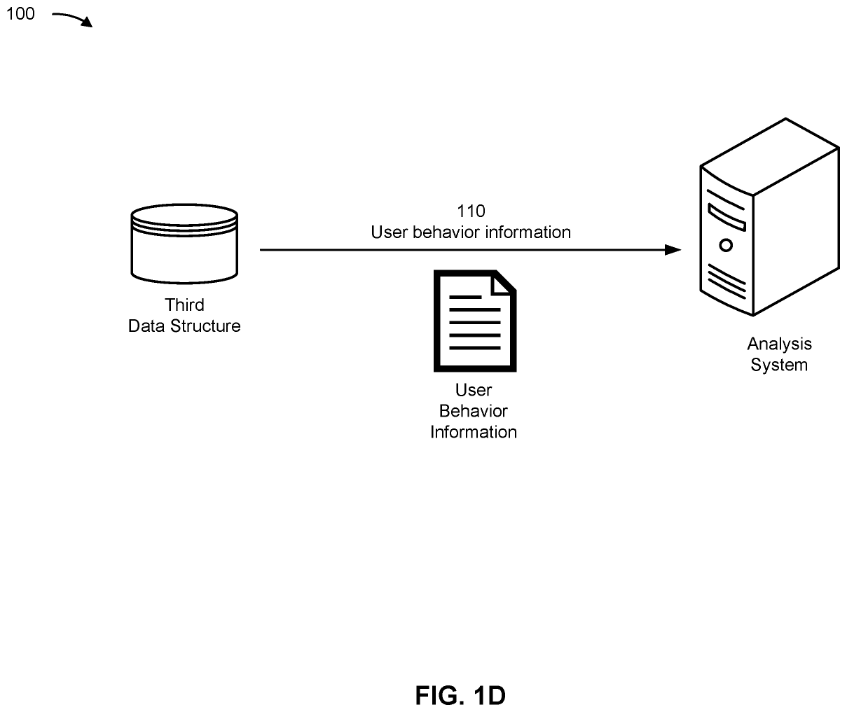

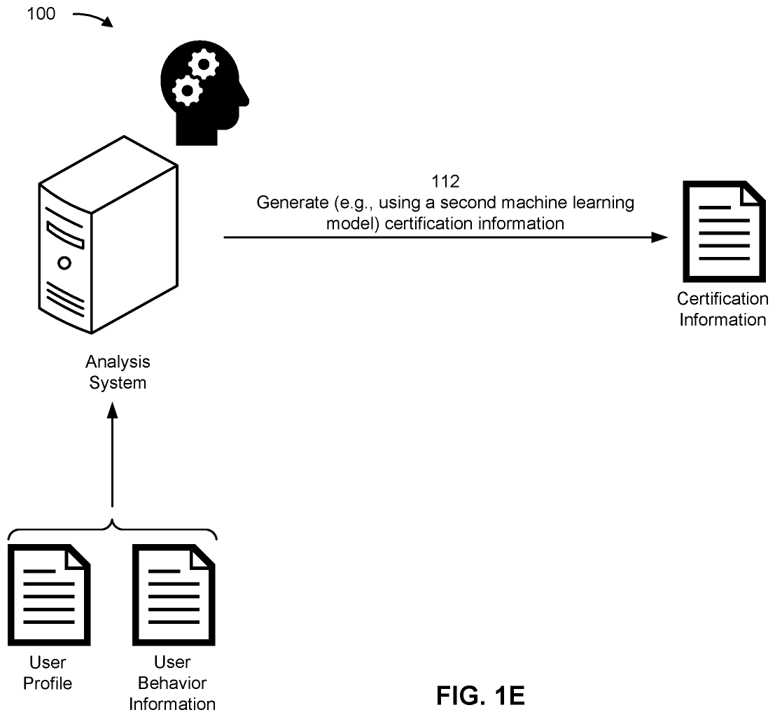

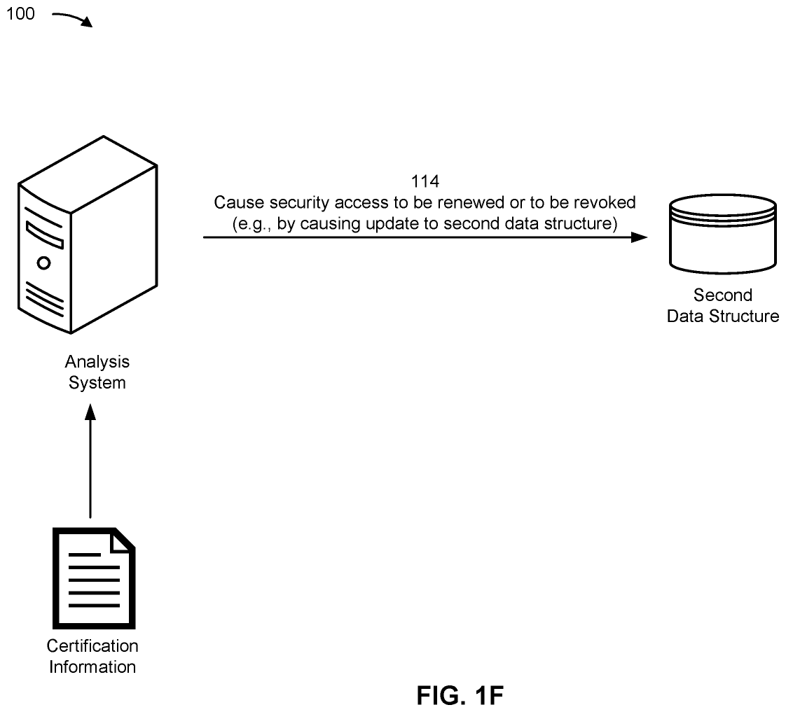

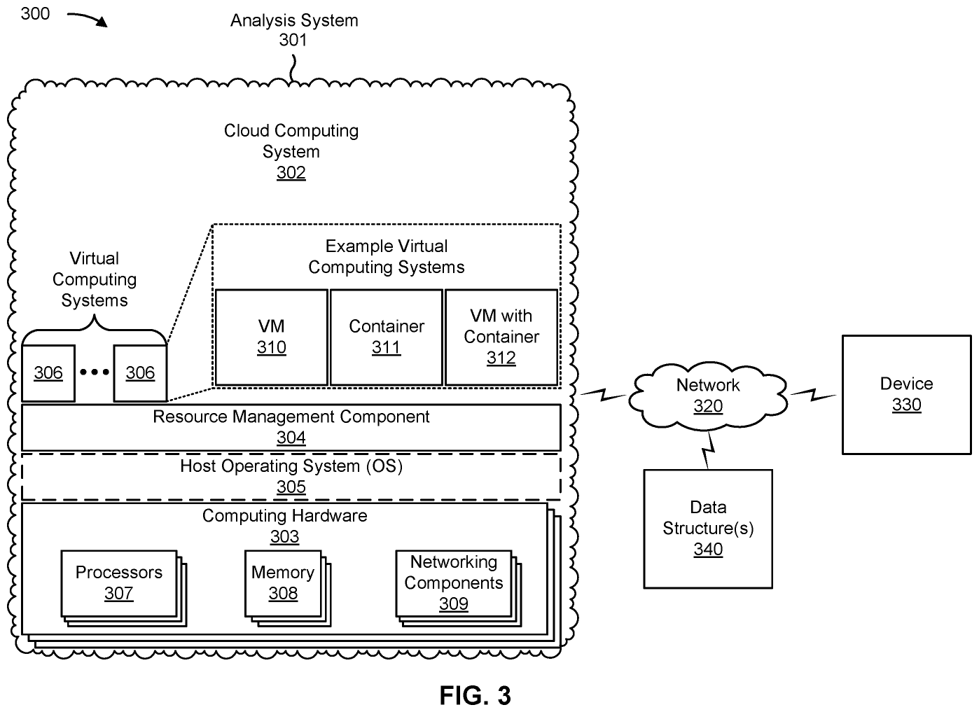

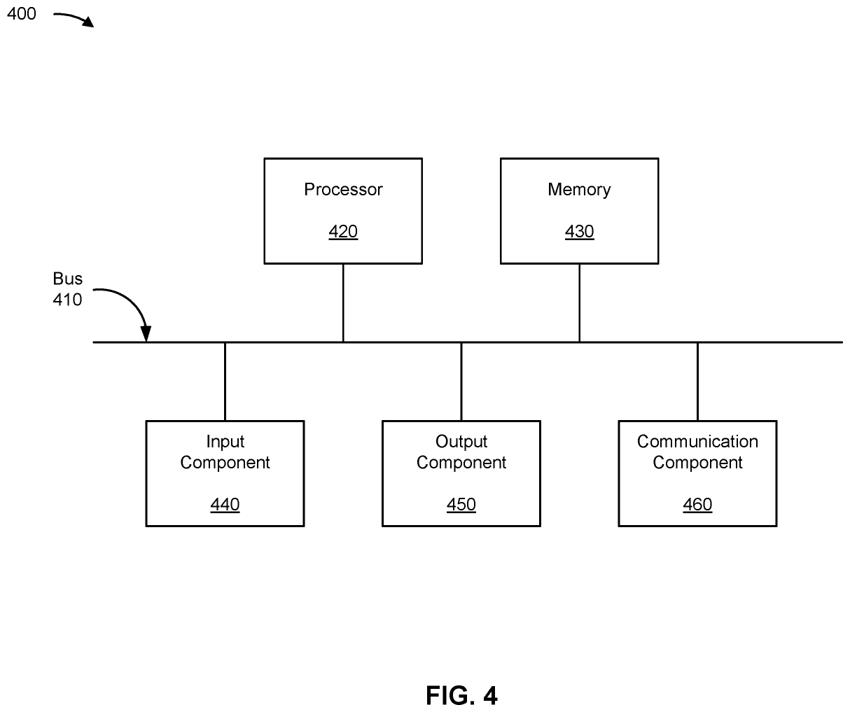

FIGS. 1A-1F are diagrams of an example implementation 100 associated with systems and methods for using artificial intelligence to facilitate security access management. As shown in FIGS. 1A-1F, example implementation 100 includes an analysis system, a device, and one or more data structures (shown as a first data structure, a second data structure, and a third data structure), which are described in more detail below in connection with FIG. 3 and FIG. 4. The analysis system may be a system for using artificial intelligence to facilitate security access management, and the device may be a device for communicating with the analysis system in association with security access management.

As shown in FIG. 1A, and by reference number 102, the device may transmit a security access grant request to the analysis system. The device may transmit the security access grant request to the analysis system to request, for a user (e.g., of the device), a grant for a security access (also referred to as an entitlement), such as to a resource, an environment, or an ability within a computer system or network. The security access grant request may identify a security access and may include, for example, identification information associated with the user (e.g., a username, an identification number, an email address, and/or other identification information). In some implementations, the device may transmit the security access grant request to the analysis system via a communication link between the device and the analysis system. Accordingly, the analysis system may obtain the security access grant request from the device (e.g., receive the security access grant request via the communication link).

As shown by reference number 104, the analysis system may obtain a user profile that is associated with the user (e.g., based on the security access grant request). The user profile information may include, for example, information associated with a security clearance level of the user, a job of the user, a title of the job, a level of the job, a description of the job, a line of business associated with the job, a project with which the user is associated, a role of the user with respect to the project, a team with which the user is associated, and/or a role of the user with respect to the team, among other examples. In some implementations, the analysis system may obtain the user profile that is associated with the user from a first data structure (e.g., that stores user profiles). For example, the analysis system may process (e.g., read and/or parse) the security access grant request to identify the identification information associated with the user, and may thereby search the first data structure to identify an entry that is associated with the identification information. The analysis system then may process (e.g., read and/or parse) the entry to obtain the user profile.

Alternatively, the analysis system may obtain (e.g., automatically obtain) the user profile based on monitoring the first data structure. For example, the analysis system may monitor the data structure and may thereby determine update information associated with the data structure. The update information may indicate that the user profile associated with the user has been added to the data structure (e.g., the user profile is a new user profile, such as due to the user being a new employee) or that the user profile has been modified within the data structure (e.g., the user profile has been updated, such as due to a change in job role or job position of the user). Accordingly, the analysis system may obtain the user profile from the data structure. For example, the analysis system may process (e.g., read and/or parse) the update information to identify an identifier associated with the user profile, and may thereby search the first data structure to identify an entry that is associated with the identifier. The analysis system then may process (e.g., read and/or parse) the entry to obtain the user profile.

As shown in FIG. 1B, and by reference number 106, the analysis system may determine (e.g., based on the user profile) whether the user is to be granted a security access. That is, the analysis system may determine that the user is to be granted the security access (shown as a “Grant Determination”) or that the user is to not be granted the security access (shown as a “Deny Determination”). When the analysis system determines that the user is to be granted the security access, the analysis system may perform one or more operations described herein in relation to FIGS. 1C-1F. Alternatively, when the analysis system determines that the user is to not be granted the security access, the analysis system may not perform (or may prevent the analysis system from performing) any operation described herein in relation to FIGS. 1C-1F.

In some implementations, the analysis system may determine whether the user is to be granted a security access, such as a security access indicated by the security access grant request (e.g., that was provided to the analysis system by the device). For example, the analysis system may process one or more portions of the user profile and the security access (e.g., information describing the security access) to determine whether the user is to be granted the security access. In some implementations, the analysis system may determine whether the user is to be granted the security access using a machine learning model. For example, the analysis system may apply the machine learning model to the user profile and the security access (e.g., the information describing the security access) to determine whether the user is to be granted the security access. That is, the analysis system may determine whether the user is to be granted the security access as machine learning model output of the machine learning model.

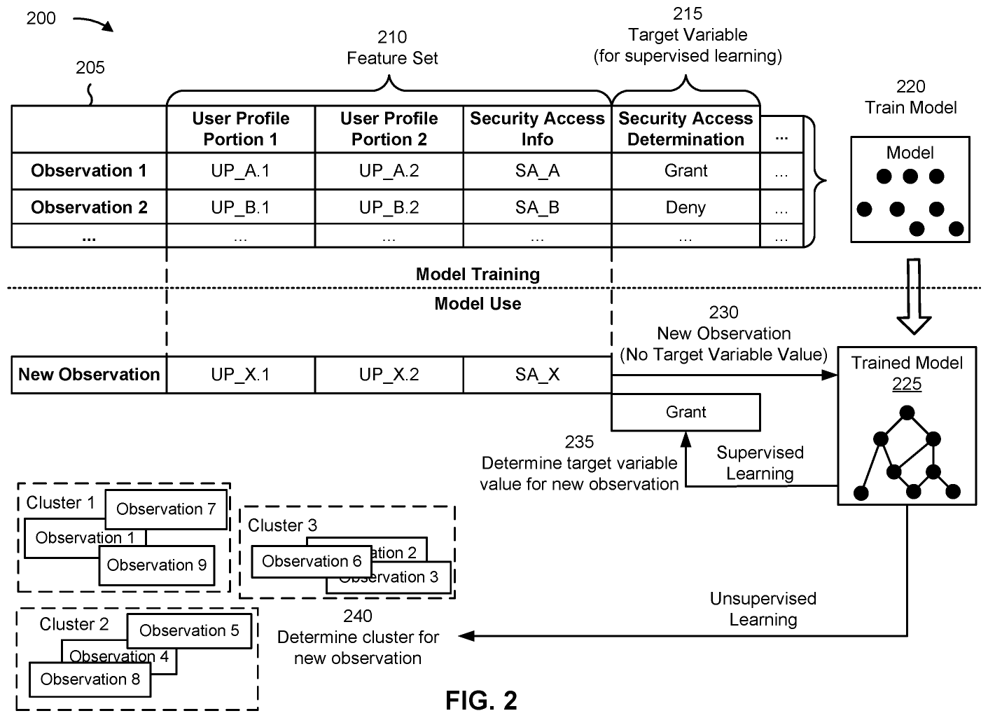

In one example, as described further in connection with FIG. 2, the machine learning model may be trained to determine an output (e.g., whether a user is to be granted a security access) based on a feature set that includes one or more features. For example, the machine learning model may be trained based on user profile training data (e.g., data associated with a plurality of user profiles that have been previously analyzed), security access training data (e.g., data associated with a plurality of security accesses that have been previously analyzed and that correspond to the plurality of user profiles) and security access determination data (e.g., that indicates security access determinations to the plurality of security accesses for the plurality of user profiles). Thus, the machine learning model may be trained to determine one or more associations and/or relationships between user profiles, security accesses, and security access determinations.

In some implementations, the analysis system may determine whether the user is to be granted one or more security accesses (e.g., regardless of whether the analysis system received a security access grant request). For example, the analysis system may determine whether the user is to be granted a security access when the user profile is a new user profile (e.g., when user is a new employee) or when the user profile has been modified (e.g., when the user has a different job role or a different job position). The analysis system may process one or more portions of the user profile to determine whether the user is to be granted a security access. In some implementations, the analysis system may determine whether the user is to be granted a security access using a machine learning model (e.g., that is the same as, or, alternatively, different than the machine learning model described above). For example, the analysis system may apply the machine learning model to the user profile to determine whether the user is to be granted a security access. That is, the analysis system may determine whether the user is to be granted a security access as machine learning model output of the machine learning model. The machine learning model may be trained in a same manner, or a similar manner, as that described herein in relation to FIG. 2.

As shown in FIG. 1C, and by reference number 108, the analysis system may cause a security access to be granted (e.g., based on determining that the user is to be granted the security access, as described herein in relation to FIG. 1B). In some implementations, to cause the security access to be granted, the analysis system may cause a second data structure (e.g., that stores security access grant information) to indicate that the user is granted the security access. For example, the analysis system may update (e.g., directly update) the second data structure to indicate that the user is granted the security access. As an alternative example, the analysis system may cause the second data structure to be updated (e.g., by updating the second data structure) to indicate that the user is recommended to be granted the security access. This may allow a notification to be provided (e.g., by a system or device monitoring the second data structure) to another device (e.g., the device described herein in relation to FIG. 1A, or a different device) associated with another user (e.g., a manager, an administrator, or another user with authority to grant security accesses), which may allow the other user to interact with the other device (e.g., via an input component of the other device) to cause the other device to update the second data structure to indicate that the user is granted the security access.

As shown in FIG. 1D, and by reference number 110, the analysis system may obtain user behavior information associated with the user (e.g., based on causing the security access to be granted to the user). The user behavior information may include, for example, information that indicates how the user interacts with, or uses, one or more resources, one or more environments, or one or more abilities within a computer system or network (e.g., information associated with usage of the security access, and/or one or more other security accesses, such as in association with data transfers, application access attempts, configuration changes, and/or other behaviors). The analysis system may obtain the user behavior information from a third data structure (e.g., that logs user behavior information for a plurality of users). For example, the analysis system may identify (e.g., on a scheduled basis, on an on-demand basis, on a triggered basis, or on an ad-hoc basis) identification information associated with the user, and may thereby search the third data structure to identify an entry that is associated with the identification information. The analysis system then may process (e.g., read and/or parse) the entry to obtain the user behavior information.

As shown in FIG. 1E, and by reference number 112, the analysis system may generate (e.g., based on the user profile of the user and/or the user behavior information associated with the user) certification information that indicates whether the security access (e.g., that the analysis system caused to be granted to the user, as described herein in relation to FIG. 1C) is to be renewed or revoked. In some implementations, the analysis system may process one or more portions of the user profile (or an updated version of the user profile, obtained in a similar manner as that described herein in relation to FIG. 1A) and/or one or more portions of the user behavior information to generate the certification information. In some implementations, the analysis system may use a machine learning model to generate the certification information.

In some implementations, the analysis system may use a same, or similar, machine learning model, as one of the machine learning models described above, to generate the certification information. For example, the analysis system may apply a machine learning model (e.g., that is trained to determine whether a user is to be granted a security access) to the user profile (e.g., may process the user profile and/or the user behavior information using the machine learning model) to determine whether the user continues to need granting of the security access. Accordingly, the analysis system may generate the certification information based on the output of the machine learning model, such that the certification information indicates that the security access is to be renewed when the machine learning model output indicates that the user continues to need grant of the security access, and that the certification information indicates that the security access is to be revoked when the user behavior classification indicates that the user does not continue to need grant of the security access.

In some implementations, the analysis system may use a machine learning model that is different than any of the machine learning models described above to generate the certification information. For example, the analysis system may apply a machine learning model to the user profile and/or the user behavior information (e.g., may process the user profile and/or the user behavior information using the machine learning model) to determine a user behavior classification (e.g., as an output of the machine learning model). The user behavior classification may indicate, for example, whether behavior of the user is normal user behavior. The machine learning model may be trained in a same manner, or a similar manner, as that described herein in relation to FIG. 2. Accordingly, the analysis system may generate the certification information based on the user behavior classification, such that the certification information indicates that the security access is to be renewed when the user behavior classification indicates normal user behavior, and that the certification information indicates that the security access is to be revoked when the user behavior classification indicates not normal user behavior.

As another example, the analysis system may apply the machine learning model to the user profile and/or the user behavior information (e.g., may process the user profile and/or the user behavior information using the machine learning model) to determine a temporal indicator of usage of the security access by the user (e.g., as an output of the machine learning model). The temporal indicator may indicate, for example, whether usage of the security access by the user is recent (e.g., sufficiently recent, such as within a threshold number of minutes, hours, or days). The machine learning model may be trained in a same manner, or a similar manner, as that described herein in relation to FIG. 2. Accordingly, the analysis system may generate the certification information based on the temporal indicator, such that the certification information indicates that the security access is to be renewed when the temporal indicator indicates recent usage of the security access by the user, and that the certification information indicates that the security access is to be revoked when the temporal indicator indicates not recent usage of the security access by the user.

In some implementations, the analysis system may use one or more of the machine learning models described herein to determine user information, which, accordingly, may indicate whether the user continues to need grant of the security access, whether behavior of the user is normal user behavior, and/or whether usage of the security access by the user is recent, among other examples. The analysis system then may generate the certification information based on the user information. For example, the analysis system may generate the certification information to indicate that the security access is to be renewed when the user information indicates that the user continues to need grant of the security access, the behavior of the user is normal user behavior, and/or that usage of the security access by the user is recent. As an alternative example, the analysis system may generate the certification information to indicate that the security access is to be revoked when the user information indicates that at least one of: the user does not continue to need grant of the security access, the behavior of the user is not normal user behavior, or the usage of the security access by the user is not a recent usage.

As shown in FIG. 1F, and by reference number 114, the analysis system may cause the security access to be renewed or to be revoked (e.g., based on the certification information). For example, the analysis system may cause the security access to be renewed when the certification information indicates that the security access is to be renewed. The analysis system may cause the security access to be renewed by not updating, or preventing updating of, the second data structure (e.g., that stores security access grant information), such that the second data structure continues to indicate that the user is granted the security access.

In some implementations, the analysis system may cause the security access to be revoked when the certification information indicates that the security access is to be revoked. To cause the security access to be revoked, the analysis system may cause the second data structure (e.g., that stores security access grant information) to indicate that the user is not granted the security access (e.g., that the user is no longer granted the security access). For example, the analysis system may update (e.g., directly update) the second data structure to indicate that the user is not granted the security access. As an alternative example, the analysis system may cause the second data structure to be updated (e.g., by updating the second data structure) to indicate that the user is not recommended to be granted the security access. This may allow a notification to be provided (e.g., by a system or device monitoring the second data structure) to another device (e.g., the device described herein in relation to FIG. 1A, or a different device) associated with another user (e.g., a manager, an administrator, or another user with authority to grant security accesses), which may allow the other user to interact with the other device (e.g., via an input component of the other device) to cause the other device to update the second data structure to indicate that the user is not granted the security access.

As indicated above, FIGS. 1A-1F are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

FIG. 2 is a diagram illustrating an example 200 of training and using a machine learning model in connection with systems and methods for using artificial intelligence to facilitate security access management. The machine learning model training and usage described herein may be performed using a machine learning system. The machine learning system may include or may be included in a computing device, a server, a cloud computing environment, or the like, such as the analysis system described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the analysis system, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the analysis system. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of user profile portion 1 (e.g., a first portion of a user profile), a second feature of user profile portion 2 (e.g., a second portion of a user profile), a third feature of security access information (e.g., that identifies and/or describes a security access), and so on. As shown, for a first observation, the first feature may have a value of UP_A.1 (e.g., user profile A, feature 1), the second feature may have a value of UP_A.2 (e.g., user profile A, feature 2), the third feature may have a value of SA_A (e.g., security access A), and so on. These features and feature values are provided as examples, and may differ in other examples. For example, the feature set may include one or more of the following features: user behavior information, business practices information, human resources information, professional community information, security access request information, and/or security access risk assessment information, among other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is a security access determination, which has a value of “Grant” for the first observation.

The target variable may represent a value that a machine learning model is being trained to determine, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, a singular value decomposition algorithm, a deep learning algorithm, a reinforcement learning human feed algorithm, or the like. For example, using a neural network algorithm, the machine learning system may train a machine learning model to output (e.g., at an output layer) a security access determination based on an input (e.g., one or more portions of a user profile and security access information), as described elsewhere herein. In particular, the machine learning system, using the neural network algorithm, may train the machine learning model, using the set of observations from the training data, to derive weights for one or more nodes in the input layer, in the output layer, and/or in one or more hidden layers (e.g., between the input layer and the output layer). Nodes in the input layer may represent features of a feature set of the machine learning model, such as a first node representing a user profile portion 1, a second node representing a user profile portion 2, a third node representing security access information, and so forth. One or more nodes in the output layer may represent output(s) of the machine learning model, such as a node indicating a security access determination. The weights learned by the machine learning model may facilitate transformation of the input of the machine learning model to the output of the machine learning model. After training, the machine learning system may store the machine learning model as a trained machine learning model 225 to be used to analyze new observations.

As an example, the machine learning system may obtain training data for the set of observations based on user profile training data (e.g., data associated with a plurality of user profiles that have been previously analyzed), security access training data (e.g., data associated with a plurality of security accesses that have been previously analyzed and that correspond to the plurality of user profiles) and security access determination data (e.g., that indicates security access determinations associated with the plurality of security accesses for the plurality of user profiles). The machine learning system may obtain the training data from one or more data structures, described herein, that are associated with the analysis system.

As shown by reference number 230, the machine learning system may apply the trained machine learning model 225 to a new observation, such as by receiving a new observation and inputting the new observation to the trained machine learning model 225. As shown, the new observation may include a first feature of UP_X.1 (e.g., user profile X, feature 1), a second feature of UP_X.2 (e.g., user profile X, feature 2), a third feature of SA_X (e.g., security access X), and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of “Grant” for the target variable of security access determination for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, a recommendation to grant the security access. The first automated action may include, for example, causing the security access to be granted.

As another example, if the machine learning system were to predict a value of “Deny” for the target variable of security access determination, then the machine learning system may provide a second (e.g., different) recommendation (e.g., a recommendation to grant the security access) and/or may perform or cause performance of a second (e.g., different) automated action (e.g., causing the security access to be denied).

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., “Grant Determination”), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above.

As another example, if the machine learning system were to classify the new observation in a second cluster (e.g., “Deny Determination”), then the machine learning system may provide a second (e.g., different) recommendation (e.g., the second recommendation described above) and/or may perform or cause performance of a second (e.g., different) automated action, such as the second automated action described above.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model). For example, the feedback information may include whether the predicted value is accurate.

In this way, the machine learning system may apply a rigorous and automated process for making a security access determination. The machine learning system may enable recognition and/or identification of tens, hundreds, thousands, or millions of features and/or feature values for tens, hundreds, thousands, or millions of observations, thereby increasing accuracy and consistency and reducing delay associated with making a security access determination relative to requiring computing resources to be allocated for tens, hundreds, or thousands of operators to manually make a security access determination using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include an analysis system 301, which may include one or more elements of and/or may execute within a cloud computing system 302. The cloud computing system 302 may include one or more elements 303-312, as described in more detail below. As further shown in FIG. 3, environment 300 may include a network 320, a device 330, and/or one or more data structures 340 (referred to singularly as a data structure 340, or in the plural as data structures 340). Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the analysis system 301 may include one or more elements 303-312 of the cloud computing system 302, may execute within the cloud computing system 302, and/or may be hosted within the cloud computing system 302, in some implementations, the analysis system 301 may not be cloud-based (e.g., may be implemented outside of a cloud computing system) or may be partially cloud-based. For example, the analysis system 301 may include one or more devices that are not part of the cloud computing system 302, such as device 400 of FIG. 4, which may include a standalone server or another type of computing device. The analysis system 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The device 330 may include one or more devices capable of receiving, generating, storing, processing, and/or providing information associated with using artificial intelligence to facilitate security access management, as described elsewhere herein. The device 330 may include a communication device and/or a computing device. For example, the device 330 may include a wireless communication device, a mobile phone, a user equipment, a laptop computer, a tablet computer, a desktop computer, or a similar type of device. As another example, the device 330 may include a server, such as an application server, a client server, a web server, a database server, a host server, a proxy server, a virtual server (e.g., executing on computing hardware), or a server in a cloud computing system. In some implementations, the device 330 may include computing hardware used in a cloud computing system.

The data structure 340 may include one or more devices capable of receiving, generating, storing, processing, and/or providing information associated with using artificial intelligence to facilitate security access management, as described elsewhere herein. The data structure 340 may include a communication device and/or a computing device. For example, the data structure 340 may include a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the data structure 340 may store user profiles, security access grant information, or user behavior information, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with using artificial intelligence to facilitate security access management. The device 400 may correspond to the analysis system 301, the computing hardware 303, the device 330, and/or the data structure 340. In some implementations, the analysis system 301, the computing hardware 303, the device 330, and/or the data structure 340 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

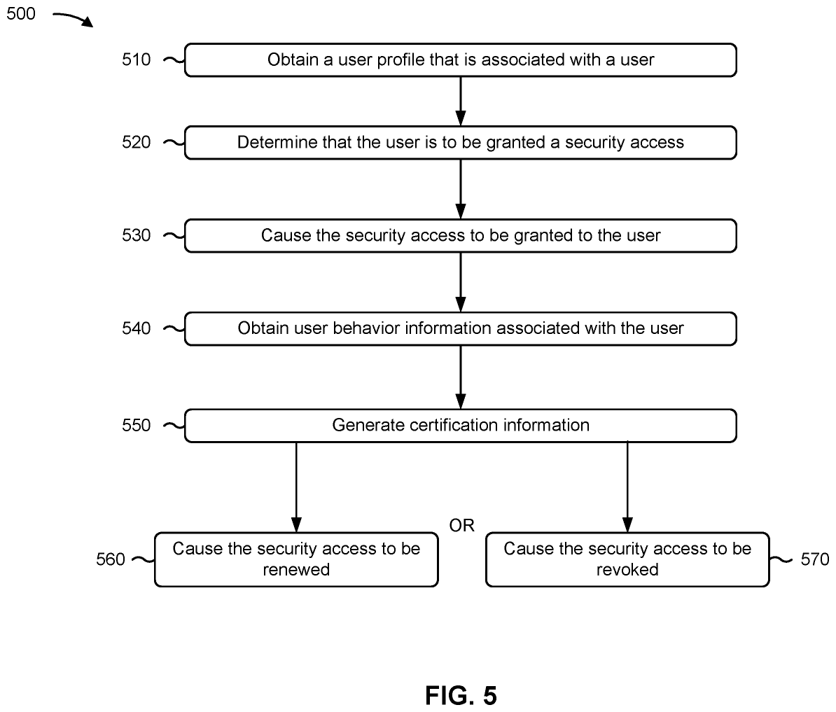

FIG. 5 is a flowchart of an example process 500 associated with systems and methods for using artificial intelligence to facilitate security access management. In some implementations, one or more process blocks of FIG. 5 may be performed by the analysis system 301. In some implementations, one or more process blocks of FIG. 5 may be performed by another device or a group of devices separate from or including the analysis system 301, such as the device 330 and/or the data structure 340. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include obtaining a user profile that is associated with a user (block 510). For example, the analysis system 301 (e.g., using processor 420 and/or memory 430) may obtain a user profile that is associated with a user, as described above in connection with reference numbers 102 and 104 of FIG. 1A. As an example, the analysis system 301 may obtain the user profile from a first data structure 340 (e.g., that stores user profiles).

As further shown in FIG. 5, process 500 may include determining that the user is to be granted a security access (block 520). For example, the analysis system 301 (e.g., using processor 420 and/or memory 430) may determine that the user is to be granted a security access, as described above in connection with reference number 106 of FIG. 1B. As an example, the analysis system 301 may determine, based on the user profile, and by using a first machine learning model, that the user is be granted a security access.

As further shown in FIG. 5, process 500 may include causing the security access to be granted to the user (block 530). For example, the analysis system 301 (e.g., using processor 420 and/or memory 430) may cause the security access to be granted to the user, as described above in connection with reference number 108 of FIG. 1C. As an example, the analysis system 301 may cause the security access to be granted by causing a second data structure 340 (e.g., that stores security access grant information) to indicate that the user is granted the security access.

As further shown in FIG. 5, process 500 may include obtaining user behavior information associated with the user (block 540). For example, the analysis system 301 (e.g., using processor 420 and/or memory 430) may obtain user behavior information associated with the user, as described above in connection with reference number 110 of FIG. 1D. As an example, the analysis system 301 may obtain, based on causing the security access to be granted to the user, user behavior information associated with the user from a third data structure 340 (e.g., that logs user behavior information for a plurality of users).

As further shown in FIG. 5, process 500 may include generating certification information (block 550). For example, the analysis system 301 (e.g., using processor 420 and/or memory 430) may generate certification information, as described above in connection with reference number 112 of FIG. 1E. As an example, the analysis system 301 may generate, based on the user behavior information, and by using a second machine learning model, certification information. The certification information may indicate whether the security access is to be renewed or revoked.

As further shown in FIG. 5, process 500 may include causing the security access to be renewed (block 560). For example, the analysis system 301 (e.g., using processor 420 and/or memory 430) may cause the security access to be renewed, as described above in connection with reference number 114 of FIG. 1F. As an example, the analysis system 301 may cause the security access to be renewed when the certification information indicates that the security access is to be renewed. The analysis system 301 may cause the security access to be renewed by not updating, or preventing updating of, the second data structure 340 (e.g., that stores security access grant information), such that the second data structure 340 continues to indicate that the user is granted the security access.

As further shown in FIG. 5, as an alternative to block 560, process 500 may include causing the security access to be revoked (block 570). For example, the analysis system 301 (e.g., using processor 420 and/or memory 430) may cause the security access to be revoked, as described above in connection with reference number 114 of FIG. 1F. As an example, the analysis system 301 may cause the security access to be revoked when the certification information indicates that the security access is to be revoked. The analysis system 301 may cause the security access to be revoked by causing the second data structure 340 (e.g., that stores security access grant information) to indicate that the user is not granted the security access (e.g., that the user is no longer granted the security access).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1F. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for using artificial intelligence to facilitate security access management, the system comprising:
one or more memories; and
one or more processors, communicatively coupled to the one or more memories, configured to:
obtain a user profile that is associated with a user;
determine, based on the user profile, and by using a first machine learning model, that the user is to be granted a security access;
cause, based on determining that the user is to be granted the security access, the security access to be granted to the user;
obtain, based on causing the security access to be granted to the user, user behavior information associated with the user;
generate, based on the user behavior information, and by using a second machine learning model, certification information that indicates whether the security access is to be renewed or revoked; and
cause, based on the certification information, one of:
the security access to be renewed when the certification information indicates that the security access is to be renewed, or
the security access to be revoked when the certification information indicates that the security access is to be revoked.

2. The system of claim 1, wherein the one or more processors, to obtain the user profile that is associated with the user, are configured to:
monitor a data structure that stores user profiles associated with a plurality of users;
determine, based on monitoring the data structure, update information associated with the data structure,
wherein the update information indicates that the user profile associated with the user has been added to the data structure or that the user profile has been modified within the data structure; and
obtain, based on the update information, the user profile from the data structure.

3. The system of claim 1, wherein the one or more processors, to obtain the user profile that is associated with the user, are configured to:
receive a security access grant request for the user;
identify, based on the security access grant request, identification information associated with the user; and
obtain, based on the identification information, the user profile from a data structure that stores user profiles associated with a plurality of users.

4. The system of claim 1, wherein the one or more processors, to cause the security access to be granted to the user, are configured to:
update a data structure that stores security access grant information to indicate that the user is granted the security access.

5. The system of claim 1, wherein the one or more processors, to cause the security access to be granted to the user, are configured to:
update a data structure that stores security access grant information to indicate that the user is recommended to be granted the security access,
wherein updating the data structure allows a notification to be provided to another device that is associated with another user, which allows the other user to interact with the other device to cause the other device to update the data structure to indicate that the user is granted the security access.

6. The system of claim 1, wherein the one or more processors, to generate the certification information, are configured to:
determine, by processing the user behavior information using the second machine learning model, a user behavior classification; and
generate, based on the user behavior classification, the certification information,
wherein the certification information indicates that the security access is to be renewed when the user behavior classification indicates normal user behavior, and
wherein the certification information indicates that the security access is to be revoked when the user behavior classification indicates not normal user behavior.

7. The system of claim 1, wherein the one or more processors, to generate the certification information, are configured to:
determine, by processing the user behavior information using the second machine learning model, a temporal indicator of usage of the security access by the user; and
generate, based on the temporal indicator, the certification information,
wherein the certification information indicates that the security access is to be renewed when the temporal indicator indicates recent usage of the security access by the user, and
wherein the certification information indicates that the security access is to be revoked when the temporal indicator indicates not recent usage of the security access by the user.

8. The system of claim 1, wherein the one or more processors, to cause the security access to be revoked, are configured to:
update a data structure that stores security access grant information to indicate that the user is not granted the security access.

9. The system of claim 1, wherein the one or more processors, to cause the security access to be revoked, are configured to:
update a data structure that stores security access grant information to indicate that the user is not recommended to be granted the security access,
wherein updating the data structure allows a notification to be provided to another device that is associated with another user, which allows the other user to interact with the other device to cause the other device to update the data structure to indicate that the user is not granted the security access.

10. A non-transitory computer-readable medium storing a set of instructions, the set of instructions comprising:
one or more instructions that, when executed by one or more processors of a system for using artificial intelligence to facilitate security access management, cause the system to:
determine, based on a user profile associated with a user, and by using a first machine learning model, that the user is to be granted a security access;
cause, based on determining that the user is to be granted the security access, the security access to be granted to the user;
generate, based on user behavior information associated with the user, and by using a second machine learning model, certification information that indicates whether the security access is to be renewed or revoked; and
cause, based on the certification information, one of:
the security access to be renewed when the certification information indicates that the security access is to be renewed, or
the security access to be revoked when the certification information indicates that the security access is to be revoked.

11. The non-transitory computer-readable medium of claim 10, wherein the one or more processors, to cause the security access to be granted to the user, are configured to:
cause a data structure to be updated to indicate that the user is granted the security access.

12. The non-transitory computer-readable medium of claim 10, wherein the one or more processors, to cause the security access to be granted to the user, are configured to:
cause a data structure to be updated to indicate that the user is recommended to be granted the security access,
wherein causing the data structure to be updated allows another device to update the data structure to indicate that the user is granted the security access.

13. The non-transitory computer-readable medium of claim 10, wherein the one or more instructions, that cause the system to generate the certification information, cause the system to:
determine, by processing the user behavior information using the second machine learning model, user information; and
generate, based on the user information, the certification information.

14. The non-transitory computer-readable medium of claim 13, wherein the certification information indicates that the security access is to be revoked when the user information indicates at least one:
a behavior of the user is not normal user behavior, or
a usage of the security access by the user is not a recent usage.

15. The non-transitory computer-readable medium of claim 10, wherein the one or more processors, to cause the security access to be revoked, are configured to:
cause a data structure to be updated to indicate that the user is not granted the security access.

16. The non-transitory computer-readable medium of claim 10, wherein the one or more processors, to cause the security access to be revoked, are configured to:
cause a data structure to be updated to indicate that the user is not recommended to be granted the security access,
wherein causing the data structure to be updated allows another device to update the data structure to indicate that the user is not granted the security access.

17. A method, comprising:
generating, by a system for using artificial intelligence to facilitate security access management, and by using one or more machine learning models, certification information that indicates whether a security access granted to a user is to be renewed or revoked; and
causing, by the system and based on the certification information, one of:
the security access to be renewed when the certification information indicates that the security access is to be renewed, or
the security access to be revoked when the certification information indicates that the security access is to be revoked.

18. The method of claim 17, further comprising:
determining, prior to generating the certification information, and by using another machine learning model, that the user is to be granted a security access; and
causing, based on determining that the user is to be granted the security access, the security access to be granted to the user.

19. The method of claim 17, wherein generating the certification information comprises:
determining, using the one or more machine learning models, user information; and
generating, based on the user information, the certification information.

20. The method of claim 19, wherein the certification information indicates that the security access is to be revoked when the user information indicates that at least one of:
a behavior of the user is not normal user behavior,
a usage of the security access by the user is not a recent usage, or
the user does not continue to need grant of the security access.
